(19) United States
(12) Patent Application Publication
(10) Pub. No.: US 2025/0037314 A1
(43) Pub. Date: Jan. 30, 2025

(54) INFORMATION PROCESSING DEVICE AND METHOD

(71) Applicant: Sony Group Corporation, Tokyo (JP)

(72) Inventors: Kenji TANAKA, Kanagawa (JP); Sundeep JOSHI, Bangalore (IN)

(73) Assignee: Sony Group Corporation, Tokyo (JP)

(21) Appl. No.: 18/706,767

(22) PCT Filed: Oct. 25, 2022
(86) PCT No.: PCT/JP2022/039651

§ 371 Date: May 2, 2024

(30) Foreign Application Priority Data
Nov. 12, 2021 (JP) 2021-184749

(51) Int. Cl. G06T 9/00

(52) U.S. Cl. CPC G06T 9/00

(57) ABSTRACT

There is provided an information processing device and method capable of improving encoding efficiency. Clustering processing of classifying each point of a point cloud representing a three-dimensional object as a set of points into a cluster for each color is performed to convert the point cloud having a normal structure, which is a data structure in which position information and color information of each point of the point cloud are indicated for each point, into the point cloud having a cluster structure, which is a data structure in which the position information of each point of the point cloud is classified into the cluster and the color information of each point is indicated for each cluster; and the point cloud of the cluster structure generated by the clustering processing is encoded. The present disclosure can be applied to, for example, an information processing device, an electronic device, an information processing method, an information processing system, a program, or the like.

### TECHNICAL FIELD

The present disclosure relates to an information processing device and method, and more particularly relates to an information processing device and method capable of reducing a decrease in encoding efficiency.

### BACKGROUND ART

Conventionally, there has been a method of encoding a point cloud representing a three-dimensional object as a set of points (see, for example, Patent Document 1).

### CITATION LIST

### Patent Document

Patent Document 1: WO 2019/142666 A

### SUMMARY OF THE INVENTION

### Problems to be Solved by the Invention

However, since the position information and the color information are indicated for each point in the point cloud, the data amount thereof also increases as the number of points increases.

The present disclosure has been made in view of such a situation, and aims to improve encoding efficiency.

### Solutions to Problems

An information processing device according to one aspect of the present technology is an information processing device including: a clustering processing unit that performs clustering processing of classifying each point of a point cloud representing a three-dimensional object as a set of points into a cluster for each color to convert the point cloud having a normal structure into the point cloud having a cluster structure; and an encoding processing unit that encodes the point cloud of the cluster structure generated by the clustering processing, in which the normal structure is a data structure in which position information and color information of each point of the point cloud are indicated for each point, and
the cluster structure is a data structure in which the position information of each point of the point cloud is classified into the cluster, and the color information of each point is indicated for each cluster.

An information processing method according to one aspect of the present technology is an information processing method including: performing clustering processing of classifying each point of a point cloud representing a three-dimensional object as a set of points into a cluster for each color to convert the point cloud having a normal structure, which is a data structure in which position information and color information of each point of the point cloud are indicated for each point, into the point cloud having a cluster structure, which is a data structure in which the position information of each point of the point cloud is classified into the cluster and the color information of each point is indicated for each cluster; and encoding the point cloud of the cluster structure generated by the clustering processing.

An information processing device according to another aspect of the present technology is an information processing device including: a decoding processing unit that decodes coded data to generate a point cloud representing a three-dimensional object as a set of points, the point cloud whose data structure is a cluster structure; and a conversion processing unit that converts the point cloud having the cluster structure generated by the decoding processing unit into the point cloud whose data structure is a normal structure, in which the normal structure is a data structure in which position information and color information of each point of the point cloud are indicated for each point, and the cluster structure is a data structure in which the position information of each point of the point cloud is classified into clusters, and the color information of each point is indicated for each cluster.

An information processing method according to another aspect of the present technology is an information processing method including: generating a point cloud, which represents a three-dimensional object as a set of points by decoding coded data, the point cloud having a cluster structure which is a data structure in which position information of each point of the point cloud is classified into clusters, and color information of each point is indicated for each of the clusters; and converting the point cloud of the generated cluster structure into the point cloud of a normal structure which is a data structure in which the position information and the color information of each point of the point cloud are indicated for each point.

In an information processing device and method according to one aspect of the present technology, clustering processing of classifying each point of a point cloud representing a three-dimensional object as a set of points into a cluster for each color is performed to convert the point cloud having a normal structure, which is a data structure in which position information and color information of each point of the point cloud are indicated for each point, into the point cloud having a cluster structure, which is a data structure in which the position information of each point of the point cloud is classified into the cluster and the color information of each point is indicated for each cluster; and the point cloud of the cluster structure generated by the clustering processing is encoded.

In the information processing device and the method according to one aspect of the present technology, the coded data is decoded to generate a point cloud representing a three-dimensional object as a set of points, the point cloud having a cluster structure which is a data structure in which the position information of each point of the point cloud is classified into clusters and the color information of each point is indicated for each cluster, and the point cloud having the generated cluster structure is converted into a point cloud whose data structure is a normal structure in which the position information and the color information of each point of the point cloud are indicated for each point.

### BRIEF DESCRIPTION OF DRAWINGS

FIG. 1 is a block diagram illustrating a main configuration example of an encoding device.

FIG. 2 is a diagram illustrating an example of a normal structure.

FIG. 3 is a diagram illustrating an example of a cluster structure.

FIG. 4 is a diagram illustrating an example of a block.

FIG. 5 is a diagram illustrating an example of blocking.

FIG. 6 is a diagram illustrating another example of a data structure.

FIG. 7 is a flowchart illustrating an example of a flow of an encoding process.

FIG. 8 is a block diagram illustrating a main configuration example of a decoding device.

FIG. 9 is a flowchart illustrating an example of a flow of a decoding process.

FIG. 10 is a block diagram illustrating a main configuration example of a computer.

### MODE FOR CARRYING OUT THE INVENTION

Hereinafter, modes for carrying out the present disclosure (hereinafter referred to as embodiments) will be described. Note that the description will be made in the following order.
1. Encoding of point cloud
2. First embodiment (encoding device)
3. Second embodiment (decoding device)
4. Appendix

### 1. Point Cloud Encoding

### Documents and the Like That Support Technical Contents and Technical Terms

The scope disclosed in the present technology includes, in addition to the contents disclosed in the embodiments, contents described in following Non-Patent Documents and the like known at the time of filing, the contents of other documents referred to in following Non-Patent Documents and the like.

Patent Document 1: (described above)

That is, the contents described in the above-described Non-Patent Documents, the contents of other documents referred to in the above-described Non-Patent Documents, and the like are also basis for determining the support requirement.

### Clustering of Position Information for Each Color

Conventionally, for example, as described in Patent Document 1, there has been a method of encoding a point cloud representing a three-dimensional object as a set of points. In such a point cloud, since the position information and the color information are indicated for each point, the data amount thereof also increases as the number of points increases. Therefore, there has been a possibility that the data amount of the coded data of the point cloud also increases.

For example, in a case where such coded data of a point cloud is provided to a client as the 3D information of the 6DoF content in which a viewpoint position, a line-of-sight direction, and the like of the 2D image to be displayed can be arbitrarily set, since the viewpoint position, the line-of-sight direction, and the like at the time of display are free, a scale (the number of points) of the point cloud is generally larger (that is, the number of points is relatively large). That is, further improvement in point cloud encoding efficiency is required.

For example, in a non-compression point group format such as PLY, data of a total of six parameters including position information (x, y, z) and color information (r, g, b) is stored per point. In a case where an information amount of 4 bytes (in the case of float) is used for one parameter, 24 bytes of information corresponding to 6 parameters is required for one point. In addition, even if x, y, and z are each expressed by 2 bytes (0 . . . 65, 535), and r, g, and b are each expressed by 1 byte (0 . . . 255), a total of 9 bytes are required.

Even if data having a large amount of data is encoded as described above, it has been difficult to sufficiently reduce the amount of data of coded data to be transmitted.

Therefore, the position information of the point cloud is classified into clusters for each color.

For example, an information processing device includes: a clustering processing unit that performs clustering processing of classifying each point of a point cloud representing a three-dimensional object as a set of points into clusters for each color to convert a point cloud having a normal structure into a point cloud having a cluster structure; and an encoding processing unit that encodes a point cloud having a cluster structure generated by the clustering processing. Note that the above-described normal structure is a data structure in which position information and color information of each point of a point cloud are indicated for each point, and the cluster structure is a data structure in which position information of each point of a point cloud is classified into clusters, and color information of each point is indicated for each cluster.

For example, in the information processing method, clustering processing of classifying each point of a point cloud representing a three-dimensional object as a set of points into a cluster for each color is performed to convert the point cloud having a normal structure, which is a data structure in which position information and color information of each point of the point cloud are indicated for each point, into the point cloud having a cluster structure, which is a data structure in which the position information of each point of the point cloud is classified into the cluster and the color information of each point is indicated for each cluster; and the point cloud of the cluster structure generated by the clustering processing is encoded.

For example, an information processing device includes: a decoding processing unit that decodes coded data to generate a point cloud representing a three-dimensional object as a set of points, the point cloud having a cluster structure as a data structure; and a conversion processing unit that converts the point cloud having the cluster structure generated by the decoding processing unit into a point cloud having a normal structure as the data structure. Note that the above-described normal structure is a data structure in which position information and color information of each point of a point cloud are indicated for each point, and the cluster structure is a data structure in which position information of each point of a point cloud is classified into clusters, and color information of each point is indicated for each cluster.

For example, in the information processing method, the coded data is decoded to generate a point cloud representing a three-dimensional object as a set of points, the point cloud having a cluster structure which is a data structure in which the position information of each point of the point cloud is classified into clusters and the color information of each point is indicated for each cluster, and the point cloud having the generated cluster structure is converted into a point cloud whose data structure is a normal structure in which the position information and the color information of each point of the point cloud are indicated for each point.

As described above, the encoding efficiency of the point cloud can be improved.

### 2. First Embodiment

### Encoding Device

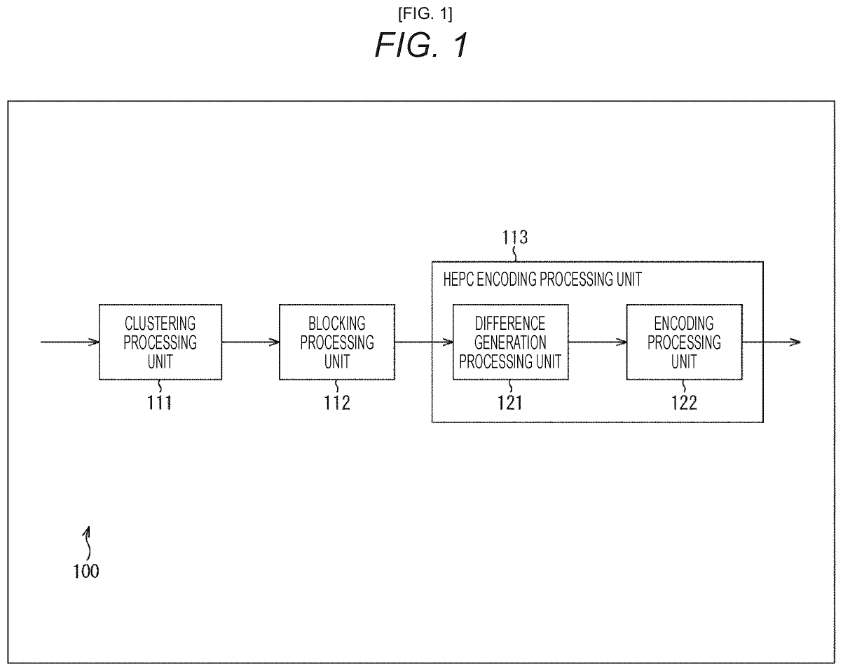

The present technology may be applied to, for example, the encoding device 100 as illustrated in FIG. 1. FIG. 1 is a block diagram illustrating an example of a configuration of the encoding device 100 in an information processing device according to an embodiment of the present technology.

The encoding device 100 illustrated in FIG. 1 encodes input point cloud data, generates coded data, and outputs the coded data. At that time, the encoding device 100 applies the present technology. That is, the encoding device 100 acquires a point cloud whose data structure is a normal structure. In the present specification, the normal structure indicates a data structure in which position information and color information of each point of a point cloud are indicated for each point. Further, (data of) the point cloud whose data structure is a normal structure is also referred to as a normal point cloud.

Then, the encoding device 100 converts the data structure of the normal point cloud into a cluster structure. In the present specification, the cluster structure indicates a data structure in which position information of each point of the point cloud is classified into clusters, and color information of each point is indicated for each cluster. In addition, (data of) the point cloud whose data structure is a cluster structure is also referred to as a cluster point cloud or a high efficiency point cloud (HEPC).

The encoding device 100 encodes the converted cluster point cloud to generate coded data. As described above, the normal point cloud is converted into the cluster point cloud (that is, the data structure of the point cloud is converted from the normal structure to the cluster structure), so that the encoding device 100 can reduce the data amount of the point cloud as compared with that before the conversion. Therefore, the encoding device 100 encodes the cluster point cloud, so that the encoding device 100 can generate coded data having a smaller amount of data than a case of encoding the normal point cloud. That is, the encoding device 100 can improve the encoding efficiency as compared with the case of encoding the normal point cloud.

Note that, in FIG. 1, main parts of the processing units, data flows, and the like are illustrated, and those illustrated in FIG. 1 are not necessarily all. That is, in the encoding device 100, there may be a processing unit not illustrated as a block in FIG. 1, or there may be processing or a data flow not illustrated as an arrow or the like in FIG. 1.

As illustrated in FIG. 1, the encoding device 100 includes a clustering processing unit 111, a blocking processing unit 112, and an HEPC encoding processing unit 113. Note that the HEPC encoding processing unit 113 includes a difference generation processing unit 121 and an encoding processing unit 122.

### Clustering Processing Unit

The clustering processing unit 111 acquires a normal point cloud supplied from an outside of the encoding device 100. The clustering processing unit 111 performs clustering processing on the normal point cloud to generate a cluster point cloud.

The clustering processing is a process of classifying a certain set according to a certain rule. Here, processing of classifying each point of a point cloud into clusters for each color is referred to as clustering processing. Note that a subset grouped by the clustering processing is referred to as a cluster. That is, the clustering processing is a process of classifying each point for each color and generating a cluster to which points of the same color belong.

That is, the clustering processing unit 111 executes the above-described clustering processing on the normal point cloud to convert the data structure from the normal structure to the cluster structure. In other words, the clustering processing unit 111 performs clustering processing of classifying each point of a point cloud representing a three-dimensional object as a set of points into clusters for each color to convert a point cloud having a normal structure into a point cloud having a cluster structure.

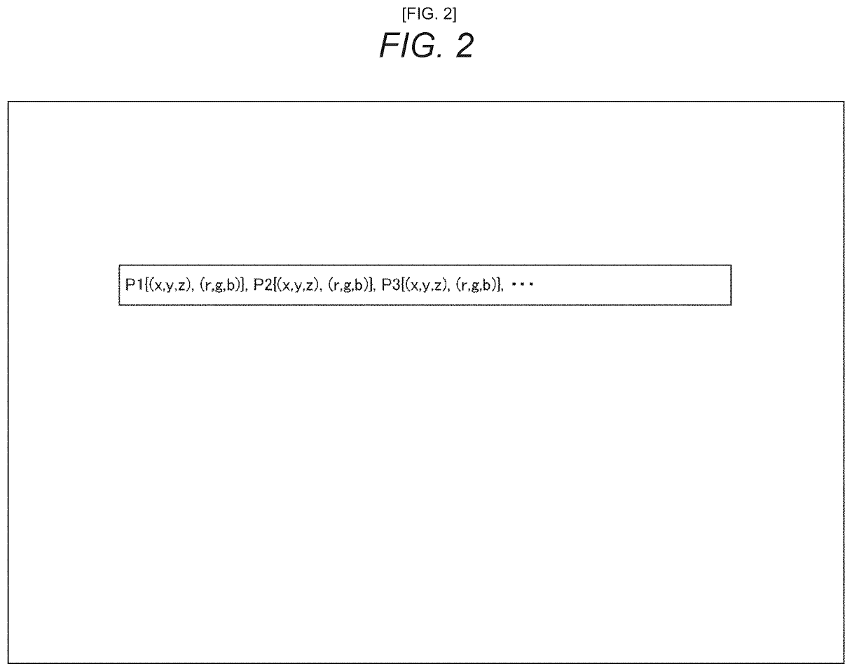

FIG. 2 illustrates an example of the point cloud having the normal structure. As illustrated in FIG. 2, in the case of the normal point cloud, position information [(x, y, z)] and color information [(r, g, b)] of each point (P1, P2, P3, . . . ) of the point cloud are indicated for each point.

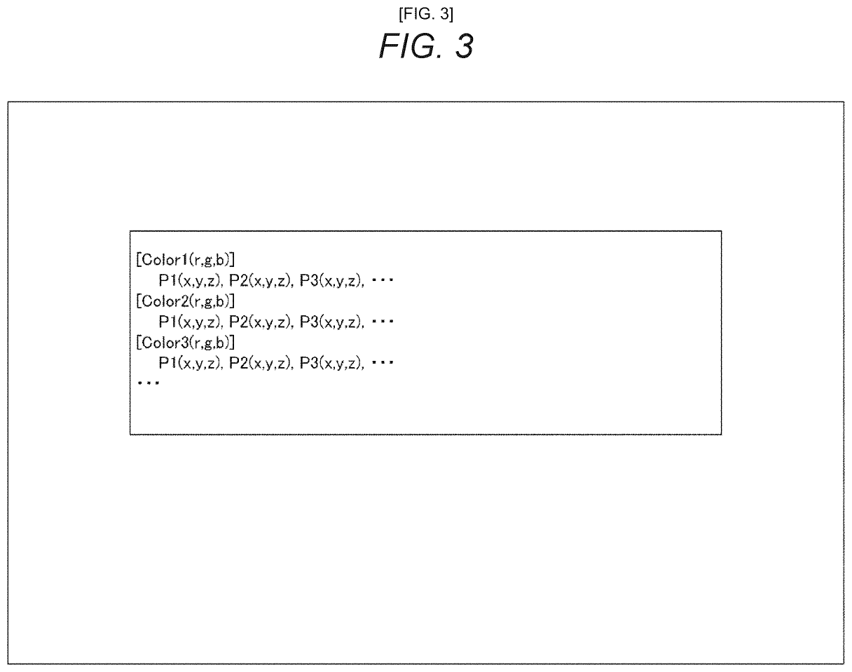

FIG. 3 illustrates an example of the point cloud having the cluster structure. As illustrated in FIG. 3, in the case of the cluster point cloud, position information [(x, y, z)] of each point (P1, P2, P3, . . . ) of the point cloud is classified for each color information [(r, g, b)]. Then, the color information [(r, g, b)] is indicated for each cluster, and only the position information [(x, y, z)] of each point in the cluster (points of the same color) is indicated. Therefore, the data amount of the point cloud in the cluster structure is smaller than that in the normal structure. That is, the clustering processing unit 111 can reduce the data amount of the point cloud by executing the clustering processing.

Note that the color (palette color) of each cluster is arbitrary. The color may be different from that of the normal point cloud. That is, the clustering processing unit 111 may convert the color information of each point into the color of each cluster in the clustering processing. An algorithm of the conversion is arbitrary.

The number of clusters (the number of colors) is arbitrary. For example, the number of clusters (that is, the number of pieces of color information of the cluster) may be smaller than the number of pieces of color information of a normal point cloud. For example, a normal point cloud having color information of full colors may be classified into clusters of 256 colors (8 bits) by clustering processing. As the number of clusters (the number of colors) is reduced, the data amount of the cluster point cloud can be reduced.

For example, it can be interpreted as processing of clustering information distributed in a (r, g, b) space (one point corresponds to one data) into n clusters (where n is the number of colors to be targeted). For example, in a case where n=256 and the total number of points is 1 million, processing of classifying 1 million data into 256 clusters is performed. The index color of about n=256 is also used in image compression such as GIF, and image quality is not significantly deteriorated due to color reduction.

Note that the color information of each cluster in the cluster point cloud may be indicated by an index number. In this case, for example, the clustering processing unit 111 may add a correspondence table of index numbers and color information to the cluster point cloud.

The clustering processing unit 111 supplies the cluster point cloud generated as described above to the blocking processing unit 112.

### Blocking Processing Unit

The blocking processing unit 112 divides the entire three-dimensional area into blocks of a predetermined size so that the position information of the cluster point cloud can be expressed by a predetermined data size, and uses the position information in the blocks to express the position information of each point.

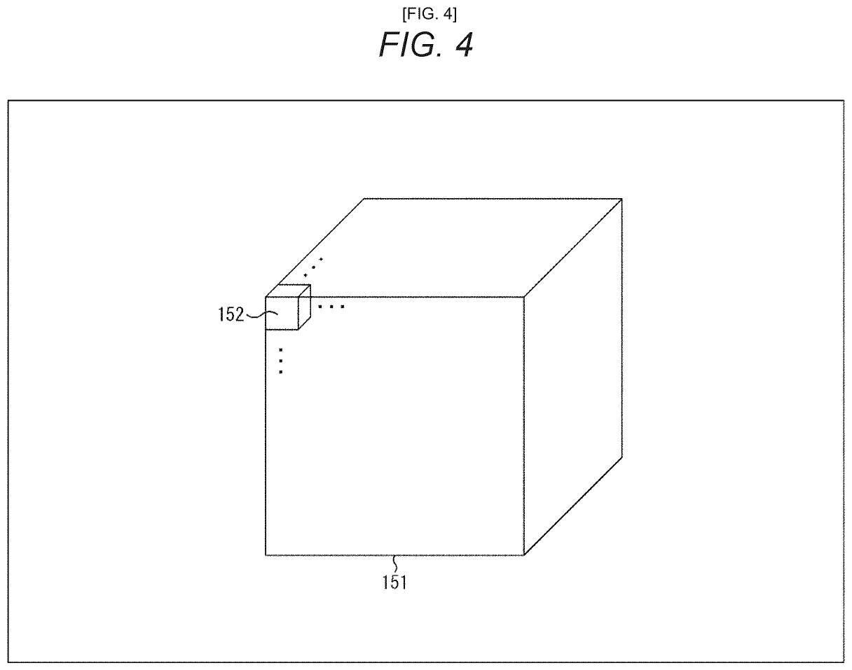

For example, as illustrated in FIG. 4, the blocking processing unit 112 divides a bounding box 151 into a plurality of blocks 152. Then, the blocking processing unit 112 expresses the position information of each point using the position information in the block 152. Since the block 152 has a smaller area than the bounding box 151, the position information in the block 152 can be expressed with a smaller amount of data. For example, a space is blocked to a size that can be expressed by 1 byte for each of x, y, and z. For example, if the accuracy of x, y, and z is 1 mm, each of x, y, and z in each block can be expressed by 1 byte when the block is divided into a cube having one side of 256 mm. In this way, one point can be represented by 3 bytes in the block, so that efficient data recording can be realized.

That is, the blocking processing unit 112 executes blocking processing on the supplied cluster point cloud. In the present specification, the blocking processing indicates a process of converting the data structure of the position information of the cluster point cloud into a block structure. In addition, the block structure is a data structure indicating position information of each point by a combination of the position information of the block and the position information in the block indicated for each point.

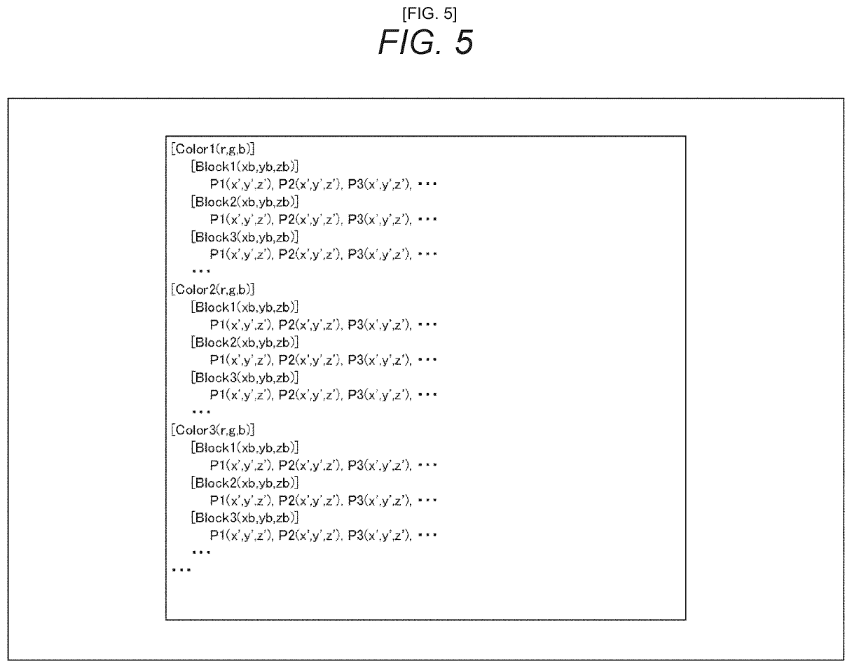

FIG. 5 illustrates an example of a data structure after blocking. As illustrated in FIG. 5, the color information of the point cloud in this case is designated for each cluster. Further, the position information is indicated by a combination of the position information of the block indicated for each block and the position information in the block indicated for each point. Therefore, the amount of data per point can be reduced.

Note that the number of blocks to be generated is arbitrary. In addition, a shape of each block is arbitrary. For example, the block sizes in the respective coordinate directions may or may not be equal. In addition, the shapes and sizes of all the blocks may not be the same.

In addition, the block of an area where the point does not exist may be omitted. With the above structure, an increase in the number of unnecessary blocks can be suppressed, so that the same range can be expressed by a smaller number of blocks. That is, a wider range can be expressed by the same number of blocks. With a reduction in the number of blocks, the data amount of the point cloud can be further reduced.

Furthermore, in this blocking processing, the blocking processing unit 112 may add information regarding the block for each block to the point cloud. For example, the blocking processing unit 112 may add the identification information (index number or the like) of the block, the position information of the reference position of the block, the information indicating the range of the block, the number of included points, and the like to the point cloud as the information regarding the block.

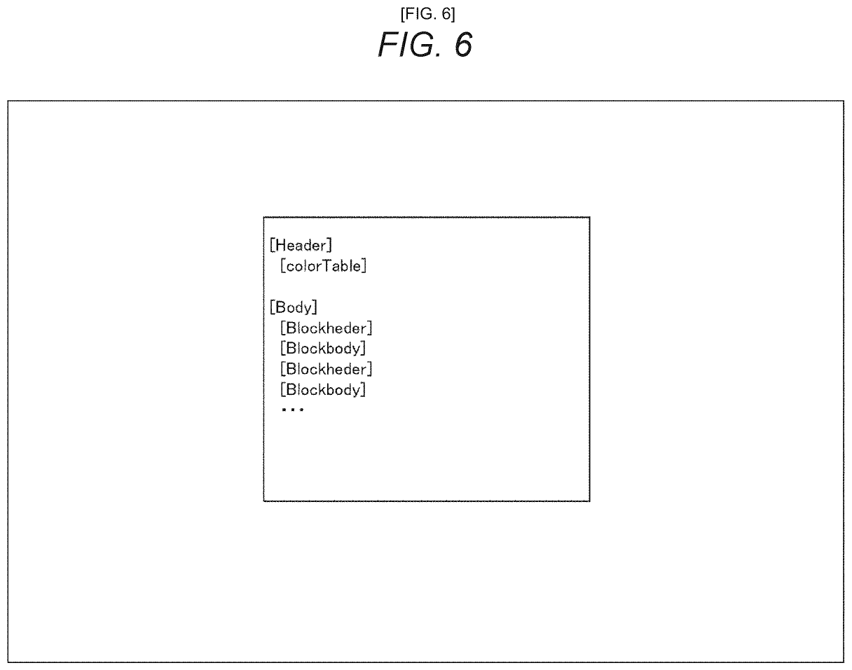

For example, the point cloud may have a data structure as illustrated in FIG. 6, and information (range designation (coordinates), number of points, number of colors, number of blocks, and the like) of the entire area may be indicated in [Header]. In addition, a color table (a table of index numbers and RGB values) may be added to [Header] ([colorTable]).

Further, in [Body], [Blockheder] and [Blockbody] may be added for each block. In [Blockheder], a color index number, coordinates in the entire area of the block, a block size, the number of points, and the like may be indicated. Further, in [Blockbody], the coordinates in the block of each point may be indicated.

Note that [Blockheder] may be collectively described as [BlockheaderTable] in [Header].

The blocking processing unit 112 supplies the cluster point cloud obtained by converting the data structure of the position information into the block structure by the blocking processing as described above to the HEPC encoding processing unit 113 (difference generation processing unit 121).

### HEPC Encoding Processing Unit

The HEPC encoding processing unit 113 performs processing related to encoding of a high-efficiency point cloud (HEPC).

### Difference Generation Processing Unit

The difference generation processing unit 121 generates a difference in position information of the supplied cluster point cloud between adjacent points in a case where the points are aligned in a predetermined order. First, the difference generation processing unit 121 sorts each point of the supplied cluster point cloud into one dimension (in a predetermined order, in an order so that the closest points are closest to each other as much as possible) on the basis of the position information. This sort order is arbitrary. For example, the difference generation processing unit 121 may sort each point along each axis such as Z-axis sort→Y-axis sort→X-axis sort. Furthermore, for example, the difference generation processing unit 121 may sort each point in order of the Morton code.

Then, the difference generation processing unit 121 calculates a difference between the position information of the point to be processed and the position information of a reference point by using a point next to the point to be processed as the reference point in the sorting order.

Note that the difference generation processing unit 121 may generate a difference between points positioned within a range of a predetermined size in the three-dimensional space. That is, in a case where a point next to the point to be processed is a neighboring point (a point within a predetermined range) of the point to be processed in the sorting order, the difference generation processing unit 121 may use this point as the reference point. In other words, in a case where a point next to the point to be processed is separated from the point to be processed by a predetermined standard or more, the difference generation processing unit 121 does not set the point as the reference point. That is, in that case, the difference generation processing unit 121 does not generate the difference of the point to be processed. In this case, the position information of the point to be processed is indicated by an absolute value (a value that is not a difference from the reference point).

With limitation of the range to be the reference point in this manner, the difference generation processing unit 121 can reduce a bit depth of the difference representation, and can suppress an increase in the data amount. Note that, the difference is derived without limiting the range to be used as the reference point, and then the value of the position information is reduced so that the encoding efficiency can be improved. However, with limitation of the range to be the reference point as described above, the encoding efficiency can be further improved.

Note that the shape and size of this range are arbitrary. The bit depth for differentially representing each axis coordinate may be equal or may not be equal.

In addition, a method of differentiating is arbitrary. For example, the difference generation processing unit 121 may select the differentiating method to be applied from a plurality of candidates. That is, the difference generation processing unit 121 may generate the difference by using a method selected from among a plurality of candidates for the method of generating the difference. For example, a plurality of methods in which the bit depth of the difference representation (the whole or each axial direction) is different from each other may be prepared as candidates. A distance that can be differentially represented is set according to the bit depth of the differential representation. In addition, a method of selecting a candidate is arbitrary. For example, selection may be made on the basis of external designation by a user or the like. In addition, an optimum result may be selected from the processing results of each candidate.

Furthermore, information (index or the like) indicating the applied method may be added to the point cloud. For example, flag information indicating whether or not the difference representation is applied, information indicating an application method, or the like may be added to the point cloud.

As described above, upon generating the difference as appropriate, the difference generation processing unit 121 supplies the high-efficiency point cloud (HEPC) to the encoding processing unit 122.

### Encoding Processing Unit

The encoding processing unit 122 encodes the supplied high-efficiency point cloud (HEPC). That is, the encoding processing unit 122 encodes the cluster point cloud generated by the clustering processing and generates the coded data. As described above, the position information of the cluster point cloud to be encoded may be blocked by the blocking processing unit 112, or the position information may be converted into the difference by the difference generation processing unit 121. This encoding method is arbitrary.

Upon generating the coded data, the encoding processing unit 122 outputs the generated coded data to the outside of the encoding device 100.

With the above configuration, the encoding device 100 can improve the encoding efficiency of the point cloud.

### Flow of Encoding Processing

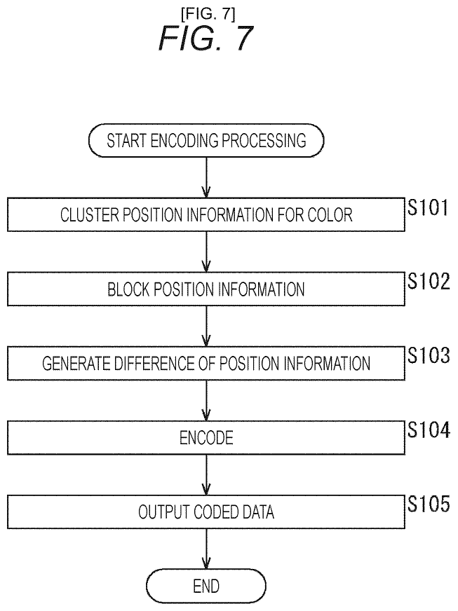

An example of a flow of an encoding process executed by the encoding device 100 will be described with reference to a flowchart of FIG. 7.

When the encoding processing is started, the clustering processing unit 111 executes the clustering processing in Step S101, and classifies the position information of the normal point cloud for each color.

In Step S102, the blocking processing unit 112 performs blocking processing to block the position information of the cluster point cloud generated in Step S101.

In Step S103, the difference generation processing unit 121 generates a difference in position information of the cluster point cloud.

In Step S104, the encoding processing unit 122 encodes the cluster point cloud to generate coded data.

In Step S105, the encoding processing unit 122 outputs the coded data to the outside of the encoding device 100.

When the processing of Step S105 ends, the encoding processing ends.

With execution of each processing as described above, the encoding device 100 can improve the encoding efficiency of the point cloud.

### 3. Second Embodiment

### Decoding Device

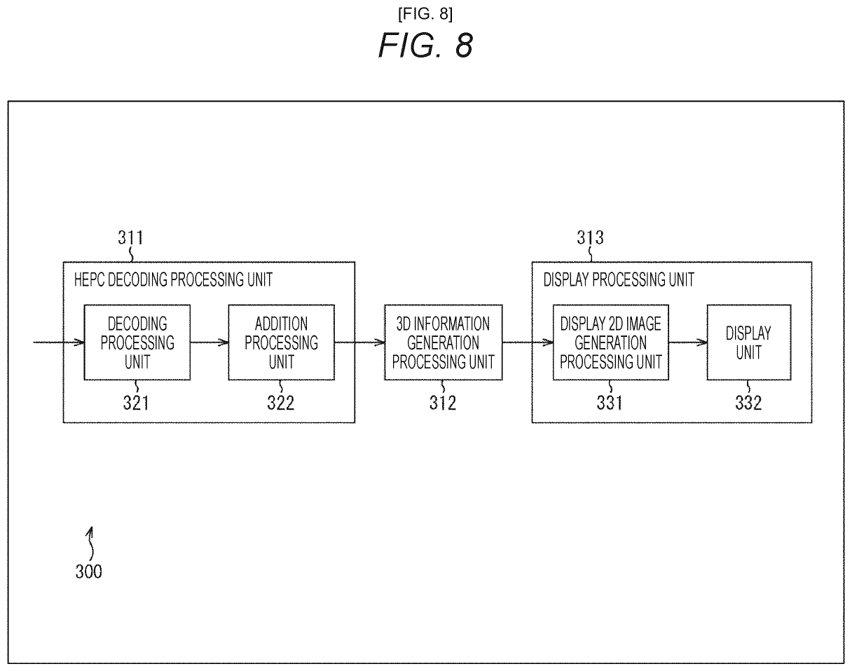

The present technology may be applied to, for example, a decoding device 300 illustrated in FIG. 8. FIG. 8 is a block diagram illustrating an example of a configuration of the decoding device 300 in an information processing device according to an embodiment of the present technology.

The decoding device 300 illustrated in FIG. 8 decodes coded data of an input cluster point cloud, generates a cluster point cloud, converts the cluster point cloud into a normal point cloud, and renders the normal point cloud to generate and display a display 2D image. Therefore, the decoding device 300 can improve the encoding efficiency as compared with the case of decoding the coded data of the normal point cloud. For example, the decoding device 300 acquires and decodes the coded data of the cluster point cloud generated by the encoding device 100 (FIG. 1).

Note that, in FIG. 8, main processing units, main data flows, and the like are illustrated, and those illustrated in FIG. 8 are not necessarily all. That is, in the decoding device 300, there may be a processing unit not illustrated as a block in FIG. 8, or there may be a process or a data flow not illustrated as an arrow or the like in FIG. 8.

As illustrated in FIG. 8, the decoding device 300 includes an HEPC decoding processing unit 311, a 3D information generation processing unit 312, and a display processing unit 313. Furthermore, the HEPC decoding processing unit 311 includes a decoding processing unit 321 and an addition processing unit 322. Furthermore, the display processing unit 313 includes a display 2D image generation processing unit 331 and a display unit 332.

### HEPC Decoding Processing Unit

The HEPC decoding processing unit 311 acquires the coded data of a high-efficiency point cloud (HEPC) input to the decoding device 300. Then, the HEPC decoding processing unit 311 decodes the coded data to generate a high-efficiency point cloud.

### Decoding Processing Unit

The decoding processing unit 321 acquires the coded data of the high-efficiency point cloud (HEPC) input to the decoding device 300. Then, the decoding processing unit 321 decodes the coded data to generate (restore) a high-efficiency point cloud, that is, a cluster point cloud. In other words, the decoding processing unit 321 decodes the coded data to generate a point cloud representing a three-dimensional object as a set of points and having a cluster structure as the data structure.

This decoding method is arbitrary as long as the method is compatible with the encoding method (that is, the encoding method applied to the coded data to be decoded) applied by the encoding processing unit 122.

Note that the position information of the cluster point cloud generated by the decoding processing unit 321 can include a difference between the point to be processed and the reference point. The decoding processing unit 321 supplies the generated cluster point cloud to the addition processing unit 322.

### Addition Processing Unit

The addition processing unit 322 acquires the cluster point cloud supplied from the decoding processing unit 321, and adds the position information to the difference included in the position information. In other words, in a case where the position information of the point to be processed is indicated by a difference from the position information of the reference point in the cluster point cloud generated by the decoding processing unit 321, the addition processing unit 322 generates the position information of the point to be processed by adding the position information of the reference point to the difference. Note that the reference point is a point next to the point to be processed in the predetermined sorting order as described above. In this manner, the addition processing unit 322 converts the position information of each point from the difference representation to the absolute value representation. Note that, in a case where the position information of the point to be processed is expressed by an absolute value, the addition processing unit 322 omits addition processing for the point to be processed.

Note that, as described above, only in a case where the point next to the point to be processed in the sorting order is positioned within a predetermined range from the point to be processed in the three-dimensional area, the point may be used as the reference point. In this case, the addition processing unit 322 may add the position information of the reference point to the difference in a case where the reference point exists in an area of a predetermined range based on the position of the point to be processed in the three-dimensional area.

The addition processing unit 322 appropriately performs addition processing, and supplies the cluster point cloud obtained by converting the position information into absolute value representation to the 3D information generation processing unit 312.

### 3D Information Generation Processing Unit

The 3D information generation processing unit 312 converts the data structure of the cluster point cloud supplied from the addition processing unit 322 to generate a normal point cloud. In other words, the 3D information generation processing unit 312 converts the point cloud having the cluster structure generated by the decoding processing unit 321 into a point cloud in which the data structure is a normal structure. That is, the 3D information generation processing unit 312 can also be referred to as a conversion processing unit.

A method of this conversion is arbitrary. For example, the 3D information generation processing unit 312 adds the color information of each cluster to the position information of each point belonging to the cluster, and merges the position information and the color information of each point classified for each cluster. That is, the 3D information generation processing unit 312 cancels the cluster structure of the cluster point cloud and converts the cluster structure into a normal structure. In other words, the 3D information generation processing unit 312 causes the position information of each point to be expressed by the position information in the entire three-dimensional area (for example, the entire bounding box).

Furthermore, as described above, the cluster point cloud to be converted may have its position information blocked. In other words, the data structure of the position information of the cluster point cloud generated by the decoding processing unit 321 may be a block structure indicating the position information of each point by a combination of the position information of the block and the position information in the block indicated for each point. Then, the 3D information generation processing unit 312 may convert the data structure of the position information from the block structure to a normal structure indicating the position information of each point by the position information in the entire three-dimensional area.

The 3D information generation processing unit 312 supplies the normal point cloud generated as described above to the display processing unit 313 (display 2D image generation processing unit 331).

### Display Processing Unit

The display processing unit 313 performs processing related to display of the normal point cloud supplied from the 3D information generation processing unit 312.

### Display 2D Image Generation Processing Unit

The display 2D image generation processing unit 331 renders the normal point cloud supplied from the 3D information generation processing unit 312 and generates a free viewpoint display 2D image. That is, the display 2D image generation processing unit 331 renders the normal point cloud so as to generate a display 2D image such as the viewpoint position and the line-of-sight direction designated by the user or the like. The display 2D image generation processing unit 331 supplies the generated display 2D image to the display unit 332.

The display unit 332 includes a display device of a 2D image, and causes the display device to display the display 2D image generated by the display 2D image generation processing unit 331. That is, the display 2D image is presented to the user.

As described above, the decoding device 300 decodes the coded data of the cluster point cloud, converts the cluster point cloud into a normal point cloud, and uses the normal point cloud to display a free viewpoint 2D image. Therefore, the decoding device 300 can improve the encoding efficiency of the point cloud.

For example, the point cloud data of about 1 million points can be compressed to about 2 Mbytes. Further, the point cloud data of about 300,000 points can be compressed to about 800 kbytes. In this case, assuming that the frame is 30 frames per second, about 24 Mbytes is obtained, and 3D data can be transmitted in a realistic band. With evaluation in terms of the amount of information per point, about 14 to 22 bits per point (bpp) are obtained.

### Flow of Decoding Processing

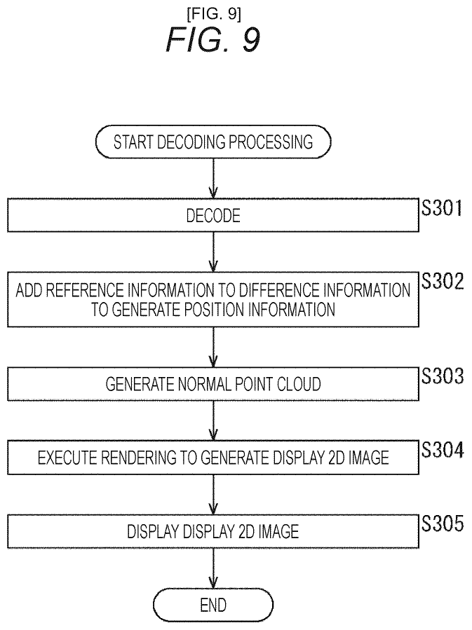

An example of the flow of decoding processing executed by this decoding device 300 will be described with reference to a flowchart of FIG. 9.

When the decoding processing is started, in Step S301, the decoding processing unit 321 decodes the coded data to generate a point cloud representing a three-dimensional object as a set of points, the point cloud having a cluster structure as the data structure in which the position information of each point of the point cloud is classified into clusters and the color information of each point is indicated for each cluster.

In Step S302, the addition processing unit 322 adds the position information of the reference point (also referred to as reference information) to the position information (also referred to as difference information) of the difference representation included in the cluster point cloud obtained in Step S301 to generate the position information of the absolute value representation.

In Step S303, the 3D information generation processing unit 312 converts the data structure of the cluster point cloud to generate a normal point cloud. In other words, the 3D information generation processing unit 312 converts the cluster point cloud into a normal point cloud. At that time, in a case where the position information of the cluster point cloud has a block structure, the 3D information generation processing unit 312 may convert the data structure of the position information into a normal structure.

In Step S304, the display 2D image generation processing unit 331 renders the normal point cloud generated by the processing in Step S303 and generates a display 2D image.

In Step S305, the display unit 332 displays the display 2D image.

When the processing in Step S305 ends, the decoding processing ends.

With execution of each processing as described above, the decoding device 300 can improve the encoding efficiency of the point cloud.

### 4. Appendix

### Computer

The above-described series of processing can be executed by hardware or software. In a case where a series of processing is executed by software, a program included in the software is installed on a computer. Here, the computer includes a computer incorporated in dedicated hardware, a general-purpose personal computer capable of executing various functions by installing various programs, and the like, for example.

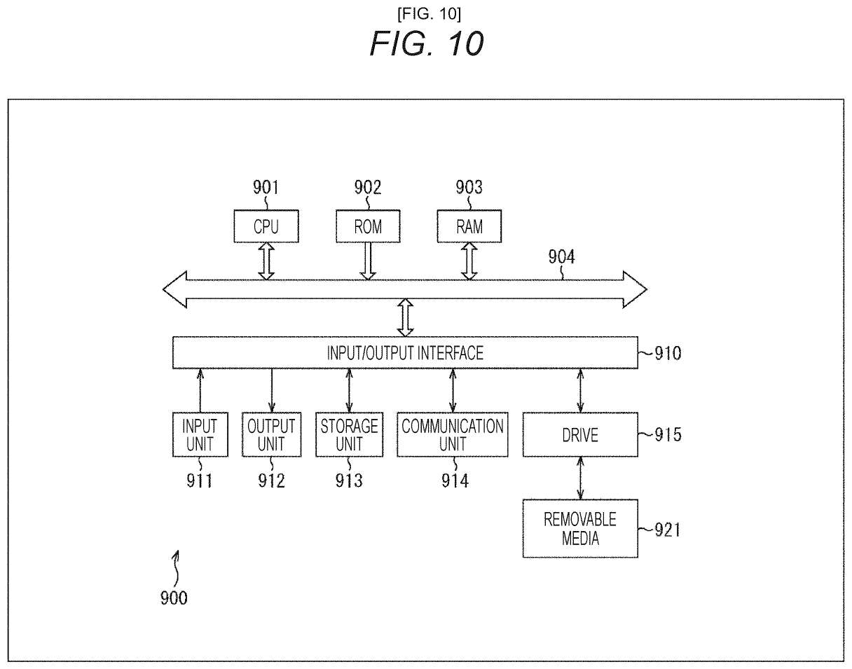

FIG. 10 is a block diagram illustrating a configuration example of hardware of a computer that executes the above-described series of processing by a program.

In a computer 900 illustrated in FIG. 10, a central processing unit (CPU) 901, a read only memory (ROM) 902, and a random access memory (RAM) 903 are interconnected through a bus 904.

Furthermore, an input/output interface 910 is also connected to the bus 904. An input unit 911, an output unit 912, a storage unit 913, a communication unit 914, and a drive 915 are connected to the input/output interface 910.

The input unit 911 includes, for example, a keyboard, a mouse, a microphone, a touch panel, an input terminal, and the like. The output unit 912 includes, for example, a display, a speaker, an output terminal, and the like. The storage unit 913 includes, for example, a hard disk, a RAM disk, a non-volatile memory and the like. The communication unit 914 includes, for example, a network interface. The drive 915 drives a removable medium 921 such as a magnetic disk, an optical disk, a magneto-optical disk, or a semiconductor memory.

In the computer configured as described above, the series of processing described above is executed, for example, by the CPU 901 loading a program stored in the storage unit 913 into the RAM 903 through the input/output interface 910 and the bus 904, and executing the program. Furthermore, the RAM 903 also appropriately stores data and the like necessary for the CPU 901 to execute various types of processing.

A program executed by the computer can be applied by being recorded on the removable medium 921 as a package medium, or the like, for example. In this case, the program can be installed in the storage unit 913 through the input/output interface 910 by attaching the removable medium 921 to the drive 915.

Furthermore, the program can also be provided through a wired or wireless transmission medium such as a local area network, the Internet, or digital satellite broadcasting. In this case, the program can be received by the communication unit 914 and installed in the storage unit 913.

In addition, this program can be installed in the ROM 902 or the storage unit 913 in advance.

### Applicable Target of Present Technology

The present technology may be applied to any configuration. For example, the present technology may be applied to various electronic devices.

Furthermore, for example, the present technology can also be implemented as a partial configuration of a device, such as a processor (for example, a video processor) as a system large scale integration (LSI) or the like, a module (for example, a video module) using a plurality of the processors or the like, a unit (for example, a video unit) using a plurality of the modules or the like, or a set (for example, a video set) obtained by further adding other functions to the unit.

Furthermore, for example, the present technology can also be applied to a network system including a plurality of devices. For example, the present technology may be implemented as cloud computing shared and processed in cooperation by a plurality of devices through a network. For example, the present technology may be implemented in a cloud service that provides a service related to an image (moving image) to any terminal such as a computer, an audio visual (AV) device, a portable information processing terminal, or an Internet of Things (IoT) device.

Note that, in the present specification, a system means a set of a plurality of components (devices, modules (parts) and the like), and it does not matter whether or not all the components are in the same housing. Therefore, a plurality of devices stored in different housings and connected over a network, and a single device including a plurality of modules stored in one housing are both regarded as systems.

### Field and Application to Which Present Technology is Applicable

The system, device, processing unit and the like to which the present technology is applied can be used in any field such as traffic, medical care, crime prevention, agriculture, livestock industry, mining, beauty care, factory, household appliance, weather, and natural surveillance, for example. Furthermore, application thereof is also arbitrary.

### Others

Note that, in the present specification, various kinds of information (such as metadata) related to coded data (a bitstream) may be transmitted or recorded in any form as long as it is associated with the coded data. Here, the term “associating” means, when processing one data, allowing other data to be used (to be linked), for example. That is, the data associated with each other may be collected as one data or may be made individual data. For example, information associated with the coded data (image) may be transmitted on a transmission path different from that of the coded data (image). Furthermore, for example, the information associated with the coded data (image) may be recorded in a recording medium different from that of the coded data (image) (or another recording area of the same recording medium). Note that, this “association” may be of not entire data but a part of data. For example, an image and information corresponding to the image may be associated with each other in any unit such as a plurality of frames, one frame, or a part within a frame.

Note that, in the present specification, terms such as “combine”, “multiplex”, “add”, “merge”, “include”, “store”, “put in”, “introduce”, and “insert” mean, for example, to combine a plurality of objects into one, such as to combine coded data and metadata into one data, and mean one method of “associating” described above.

Furthermore, the embodiments of the present technology are not limited to the above-described embodiments, and various modifications are possible without departing from the scope of the present technology.

For example, a configuration described as one device (or processing unit) may be divided and configured as a plurality of devices (or processing units). Conversely, configurations described above as a plurality of devices (or processing units) may be collectively configured as one device (or processing unit). Furthermore, it goes without saying that a configuration other than the above-described configurations may be added to the configuration of each device (or each processing unit). Moreover, when the configuration and operation as the entire system are substantially the same, a part of the configuration of a certain device (or processing unit) may be included in the configuration of another device (or another processing unit).

Furthermore, for example, the above-described programs may be executed in an arbitrary device. In this case, the device is only required to have a necessary function (functional block and the like) and obtain necessary information.

Furthermore, for example, each step in one flowchart may be executed by one device, or may be executed by being shared by a plurality of devices. Moreover, in a case where a plurality of pieces of processing is included in one step, the plurality of pieces of processing may be executed by one device, or may be shared and executed by a plurality of devices. In other words, a plurality of pieces of processing included in one step can be executed as a plurality of steps. Conversely, the processes described as the plurality of the steps can also be collectively executed as one Step.

Furthermore, the program executed by the computer may have the following features. For example, the pieces of processing of the steps describing the program may be executed in time series in the order described in the present specification. Furthermore, the pieces of processing of the steps describing the program may be executed in parallel. Moreover, the pieces of processing of the steps describing the program may be individually executed at the necessary timing, such as when the program is called. That is, the pieces of processing of the respective steps may be executed in an order different from the above-described order as long as there is no contradiction. Furthermore, the pieces of processing of steps describing this program may be executed in parallel with the pieces of processing of another program. Moreover, the pieces of processing of the steps describing this program may be executed in combination with the pieces of processing of another program.

Furthermore, for example, a plurality of technologies related to the present technology can be implemented independently as a single entity as long as there is no contradiction. It goes without saying that any plurality of present technologies can be implemented in combination. For example, a part or all of the present technologies described in any of the embodiments can be implemented in combination with a part or all of the present technologies described in other embodiments. Furthermore, a part or all of any of the above-described present technologies can be implemented together with another technology that is not described above.

Note that the present technology may also have the following configurations.
(1) An information processing device including:
a clustering processing unit that performs clustering processing of classifying each point of a point cloud representing a three-dimensional object as a set of points into a cluster for each color to convert the point cloud having a normal structure into the point cloud having a cluster structure; and
an encoding processing unit that encodes the point cloud of the cluster structure generated by the clustering process, in which
the normal structure is a data structure in which position information and color information of each point of the point cloud are indicated for each point, and
the cluster structure is a data structure in which the position information of each point of the point cloud is classified into the cluster, and the color information of each point is indicated for each cluster.
(2) The information processing device according to (1), in which
the clustering processing unit converts the color information of the point into the color information of the cluster in the clustering processing.
(3) The information processing device according to (2), in which
the number of pieces of the color information of the cluster is smaller than the number of pieces of the color information of the point cloud of the normal structure.
(4) The information processing device according to (2) or (3), in which
the point cloud of the cluster structure indicates the color information of each cluster by an index number.
(5) The information processing device according to any one of (1) to (4), further including
a blocking processing unit that performs blocking processing of converting the data structure of the position information of the point clouds having the cluster structure generated by the clustering processing into a block structure, in which
the block structure is a data structure indicating the position information of each point by a combination of position information of a block and the position information in the block indicated for each point.
(6) The information processing device according to (5), in which
the blocking processing unit adds information regarding the block for each of the blocks in the blocking processing.
(7) The information processing device according to any one of (1) to (6), further including
a difference generation processing unit that generates a difference in the position information between adjacent points in a case where each point is aligned in a predetermined order, with respect to the position information of the point clouds having the cluster structure generated by the clustering processing, in which
the encoding processing unit encodes the difference generated by the difference generation processing unit as the position information of the point cloud having the cluster structure.
(8) The information processing device according to (7), in which
the difference generation processing unit generates the difference between points located within a range of a predetermined size in a three-dimensional space.
(9) The information processing device according to (7) or (8), in which
the difference generation processing unit generates the difference by using a method selected from among a plurality of candidates for the method of generating the difference.
(10) An information processing method including:
performing clustering processing of classifying each point of a point cloud representing a three-dimensional object as a set of points into a cluster for each color to convert the point cloud having a normal structure, which is a data structure in which position information and color information of each point of the point cloud are indicated for each point, into the point cloud having a cluster structure, which is a data structure in which the position information of each point of the point cloud is classified into the cluster and the color information of each point is indicated for each cluster; and
encoding the point cloud of the cluster structure generated by the clustering processing.
(11) An information processing device including:
a decoding processing unit that decodes coded data to generate a point cloud representing a three-dimensional object as a set of points, the point cloud having a data structure of a cluster structure; and
a conversion processing unit that converts the point cloud having the cluster structure generated by the decoding processing unit into the point cloud whose data structure is a normal structure, in which
the normal structure is a data structure in which position information and color information of each point of the point cloud are indicated for each point, and
the cluster structure is a data structure in which the position information of each point of the point cloud is classified into clusters, and the color information of each point is indicated for each cluster.
(12) The information processing device according to (11), in which
the conversion processing unit adds the color information of each cluster to the position information of each point belonging to the cluster, and merges the position information and the color information of each point classified for each cluster.
(13) The information processing device according to (11) or (12), in which
a data structure of the position information of the point cloud of the cluster structure generated by the decoding processing unit is a block structure,
the conversion processing unit converts the data structure of the position information from the block structure to a normal structure,
the block structure is a data structure indicating the position information of each point by a combination of a position information of a block and position information in the block indicated for each point, and
the normal structure of the position information is a data structure indicating the position information of each point by position information in the entire three-dimensional area.
(14) The information processing device according to any one of (11) to (13), further including
an addition processing unit that adds the position information of a reference point to a difference to generate the position information of a point to be processed in a case where the position information of the point to be processed is indicated by the difference from the position information of the reference point in the point cloud having the cluster structure generated by the decoding processing unit.
(15) The information processing device according to (14), in which
the addition processing unit adds the position information of the reference point to the difference in a case where the reference point exists in an area of a predetermined range based on a position of the point to be processed in a three-dimensional area.
(16) An information processing method including:
generating a point cloud, which represents a three-dimensional object as a set of points by decoding coded data, the point cloud having a cluster structure which is a data structure in which position information of each point of the point cloud is classified into clusters, and color information of each point is indicated for each of the clusters; and
converting the point cloud of the generated cluster structure into the point cloud of a normal structure which is a data structure in which the position information and the color information of each point of the point cloud are indicated for each point.

### REFERENCE SIGNS LIST

100 Encoding device
111 Clustering processing unit
112 Block processing generation unit
113 HEPC encoding processing unit
121 Difference generation processing unit
122 Encoding processing unit
300 Decoding device
311 HEPC decoding processing unit
312 3D information generation processing unit
313 Display processing unit
321 Decoding processing unit
322 Addition processing unit
331 Display 2D image generation processing unit
332 Display unit
900 Computer

1. An information processing device comprising:
a clustering processing unit that performs clustering processing of classifying each point of a point cloud representing a three-dimensional object as a set of points into a cluster for each color to convert the point cloud having a normal structure into the point cloud having a cluster structure; and
an encoding processing unit that encodes the point cloud of the cluster structure generated by the clustering processing, wherein
the normal structure is a data structure in which position information and color information of each point of the point cloud are indicated for each point, and
the cluster structure is a data structure in which the position information of each point of the point cloud is classified into the cluster, and the color information of each point is indicated for each cluster.

2. The information processing device according to claim 1, wherein
the clustering processing unit converts the color information of the point into the color information of the cluster in the clustering processing.

3. The information processing device according to claim 2, wherein
the number of pieces of the color information of the cluster is smaller than the number of pieces of the color information of the point cloud of the normal structure.

4. The information processing device according to claim 2, wherein
the point cloud of the cluster structure indicates the color information of each cluster by an index number.

5. The information processing device according to claim 1, further comprising
a blocking processing unit that performs blocking processing of converting the data structure of the position information of the point clouds having the cluster structure generated by the clustering processing into a block structure, wherein
the block structure is a data structure indicating the position information of each point by a combination of position information of a block and the position information in the block indicated for each point.

6. The information processing device according to claim 5, wherein
the blocking processing unit adds information regarding the block for each of the blocks in the blocking processing.

7. The information processing device according to claim 1, further comprising
a difference generation processing unit that generates a difference in the position information between adjacent points in a case where each point is aligned in a predetermined order, with respect to the position information of the point clouds having the cluster structure generated by the clustering processing, wherein
the encoding processing unit encodes the difference generated by the difference generation processing unit as the position information of the point cloud having the cluster structure.

8. The information processing device according to claim 7, wherein
the difference generation processing unit generates the difference between points located within a range of a predetermined size in a three-dimensional space.

9. The information processing device according to claim 7, wherein
the difference generation processing unit generates the difference by using a method selected from among a plurality of candidates for the method of generating the difference.

10. An information processing method comprising:
performing clustering processing of classifying each point of a point cloud representing a three-dimensional object as a set of points into a cluster for each color to convert the point cloud having a normal structure, which is a data structure in which position information and color information of each point of the point cloud are indicated for each point, into the point cloud having a cluster structure, which is a data structure in which the position information of each point of the point cloud is classified into the cluster and the color information of each point is indicated for each cluster; and
encoding the point cloud of the cluster structure generated by the clustering processing.

11. An information processing device comprising:
a decoding processing unit that decodes coded data to generate a point cloud representing a three-dimensional object as a set of points, the point cloud having a data structure of a cluster structure; and
a conversion processing unit that converts the point cloud having the cluster structure generated by the decoding processing unit into the point cloud whose data structure is a normal structure, wherein
the normal structure is a data structure in which position information and color information of each point of the point cloud are indicated for each point, and
the cluster structure is a data structure in which the position information of each point of the point cloud is classified into clusters, and the color information of each point is indicated for each cluster.

12. The information processing device according to claim 11, wherein
the conversion processing unit adds the color information of each cluster to the position information of each point belonging to the cluster, and merges the position information and the color information of each point classified for each cluster.

13. The information processing device according to claim 11, wherein
a data structure of the position information of the point cloud of the cluster structure generated by the decoding processing unit is a block structure,
the conversion processing unit converts the data structure of the position information from the block structure to a normal structure,
the block structure is a data structure indicating the position information of each point by a combination of a position information of a block and position information in the block indicated for each point, and
the normal structure of the position information is a data structure indicating the position information of each point by position information in the entire three-dimensional area.

14. The information processing device according to claim 11, further comprising
an addition processing unit that adds the position information of a reference point to a difference to generate the position information of a point to be processed in a case where the position information of the point to be processed is indicated by the difference from the position information of the reference point in the point cloud having the cluster structure generated by the decoding processing unit.

15. The information processing device according to claim 14, wherein
the addition processing unit adds the position information of the reference point to the difference in a case where the reference point exists in an area of a predetermined range based on a position of the point to be processed in a three-dimensional area.

16. An information processing method comprising:
generating a point cloud, which represents a three-dimensional object as a set of points by decoding coded data, the point cloud having a cluster structure which is a data structure in which position information of each point of the point cloud is classified into clusters, and color information of each point is indicated for each of the clusters; and
converting the point cloud of the generated cluster structure into the point cloud of a normal structure which is a data structure in which the position information and the color information of each point of the point cloud are indicated for each point.
